(19) United States
(12) Patent Application Publication
(10) Pub. No.: US 2003/0056120 A1
(43) Pub. Date: Mar. 20, 2003

(54) Login method and system for use with carry-on electronic device

(76) Inventors: Hsiang-Min Liu, Taipei (TW); Shih-Li Wen, Taipei (TW)

Correspondence Address: THE LAW OFFICES OF MIKIO ISHIMARU, 1110 SUNNYVALE-SARATOGA ROAD, SUITE A1, SUNNYVALE, CA, 94087, US

(21) Appl. No.: 10/011,227

(22) Filed: Oct. 25, 2001

(30) Foreign Application Priority Data
Sep. 14, 2001 (TW) 90122946

(51) Int. Cl. H04L 9/32

(52) U.S. Cl. 713/202

(57) ABSTRACT

A login method and system for use with a carry-on electronic device are proposed, for allowing a user to login a web page server via a carry-on electronic device, so as to read or download required data from the web page server. The user who first logins the web page server needs to input a login account, an identification code and a communication number required for registering in the web page server, so as to establish and store dedicated user's data for the user in a database of the web page server. When a login request signal is submitted by the user via the carry-on electronic device to the web page server, a login account and an identification code inputted by the user are identified by the web page server, so that only the user with authorization can login the web page server for data downloading.

### FIELD OF THE INVENTION

The present invention relates to login methods and systems for use with carry-on electronic devices, and more particularly, to a login method and system for use with a carry-on electronic device, for allowing a user to be identified by a web page server so as to login the web page server through the use of a carry-on electronic device supported with wireless network communication.

### BACKGROUND OF INVENTION

With technology development from local area network, wide area network to internet, network application through the use of a computer is becoming part of human life. However, it usually happens that the computer is not available in real time for a user who desires to access a network. Therefore, in consideration of combining wireless and wired networks, the user having a mobile phone can access internet information via the wireless network, that is, the low-profile mobile phone can function as the computer for allowing the user to receive, browse and reply information through the internet.

The above-mentioned can be achieved through the use of wireless application protocol (WAP), in which a mobile device such as mobile phone and personal digital assistant (PDA) can act as a simple browser, for allowing information of world wide web (WWW) to be accessed through the wireless network via the mobile device; that is, the WAP provides the mobile phone with network access.

In order to login a web page server by using a mobile phone, first, a user needs to apply for WAP authorization and establish dedicated user's data through a computer connected to the web page server, wherein the user's data include a login account, an identification code, a mobile phone number, etc. Then, a mobile phone supported with a WAP function is connected to the web page server, and has a mobile phone number same as that of the user's data in the web page server. For example, the mobile phone can be pre-formed with a connection control button or a touch-control panel. When the user presses the control button or touches a connection pattern displayed on the panel, the mobile phone can be wirelessly connected to the web page server and download information provided by the server. Therefore, the web page server is capable of recording number of times for information downloading and the downloading time corresponding to the mobile phone number transmitted through the connection, and charges the user for network connection and information downloading according to the recorded data.

However, in such an operational mode, a user who logins the web page server for downloading information cannot be securely identified in identity, as long as a mobile phone with WAP authorization is available.

Therefore, it is desired to develop a secure login method for accessing network information via a mobile phone and also identifying a user having the mobile phone.

### SUMMARY OF THE INVENTION

A primary objective of the present invention is to provide a login method and system for use with a carry-on electronic device, for allowing a user to be identified by a web page server so as to login the web page server through the use of a carry-on electronic device supported with wireless network communication.

In accordance with the foregoing and other objectives, the present invention proposes a login method and system for use with a carry-on electronic device. The login method for use with a carry-on electronic device of the invention allows a user to login a web page server via a carry-on electronic device, so as to read or download required data from the web page server, wherein the user who first logins the web page server needs to input a login account, an identification code and a communication number required for registering in the web page server, so as to establish dedicated user's data for the user, and store the user's data in a database of the web page server.

The login method for use with a carry-on electronic device comprises the steps of: (1) determining via the web page server if a wireless communication module receives a login request signal transmitted from the carry-on electronic device, wherein if the login request signal is received, then step (2) is followed; or else, then the step (1) is repeated; (2) prompting the wireless communication module via the web page server to receive a communication number contained in the login request signal transmitted from the carry-on electronic device; (3) searching the database via the web page server for user's data corresponding to the communication number received by the wireless communication module; (4) prompting the user at the carry-on electronic device via the web page server to input a login account and an identification number required for loginning the web page server; (5) determining via the web page server if the login account and the identification number inputted by the user match those in the searched user's data, wherein if the inputted data match the searched data, then step (6) is followed; or else, the step (5) is repeated; and (6) allowing the user at the carry-on electronic device to login the web page server.

The login system for use with a carry-on electronic device of the invention comprises: at least one user having a carry-on electronic device supported with a wireless network communication function; and a web page server for allowing the user having the carry-on electronic device to login the web page server, so as to download required data to the carry-on electronic device, wherein the web page server includes a database for establishing and storing dedicated user's data of a login account, an identification code and a communication number inputted by the user; a wireless communication module for receiving a communication number contained in a wireless communication signal transmitted from the carry-on electronic device of the user; and an identifying module for searching in the database for user's data corresponding to the communication number received by the wireless communication module; then, the web page server prompts the user at the carry-on electronic device to input a login account and an identification number required for loginning the web page server, and compares the inputted login account and identification number with those in the searched user's data; and if the inputted data match the searched data, the user at the carry-on electronic device is allowed to login the web page server for data downloading.

Therefore, as concluded from the above mentioned, in the use of the login method and system for use with a carry-on electronic device of the invention, it can improve the drawback of a person without identified in identity to login a network by using a WAP mobile phone as recited in the prior art.

### BRIEF DESCRIPTION OF THE DRAWINGS

The present invention can be more fully understood by reading the following detailed description of the preferred embodiments, with reference made to the accompanying drawings wherein:

FIG. 1 is a schematic block diagram showing basic architecture of a login system for use with a carry-on electronic device of the invention; and

FIGS. 2(A)-2(B) are schematic diagrams depicting a login method for use with a carry-on electronic device in the use of a login system for use with a carry-on electronic device of the invention.

### DETAILED DESCRIPTION OF THE PREFERRED EMBODIMENT

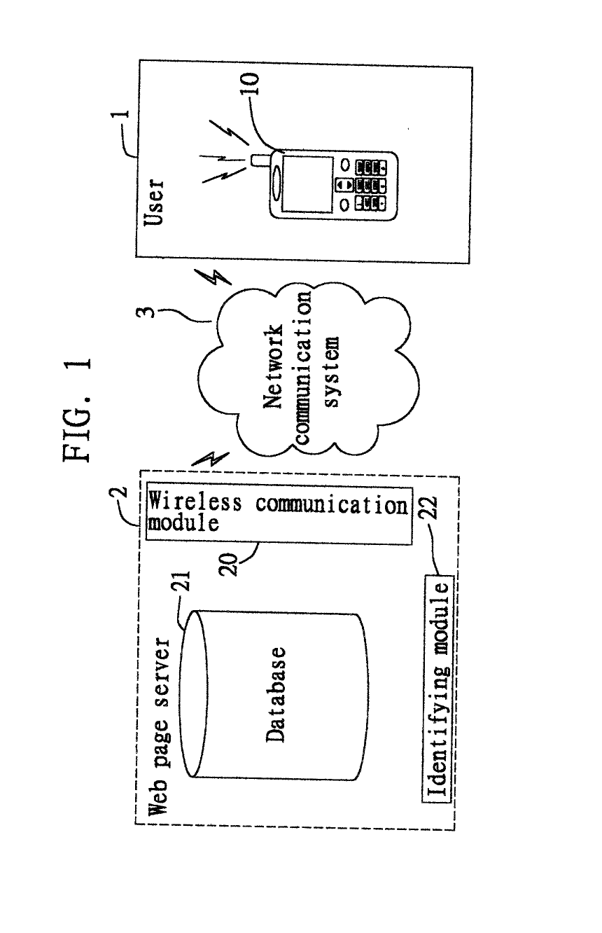

Referring to FIG. 1, it illustrates basic architecture of a login system for use with a carry-on electronic device of the invention. As shown in the drawing, in the login system for use with a carry-on electronic device of the invention, a user 1 uses a mobile phone 10 to establish connection to a web page server 2 via a network communication system 3, so as to allow the user 1 to interact with the web page server 2 in real time.

The mobile phone 10 is supported with a wireless application protocol (WAP) function. The network communication system 3 comprises: a wireless communication module 20 for receiving a wireless communication signal transmitted from the mobile phone 10 of the user 1, and for transmitting an operation signal generated by the web page server 2 to the mobile phone 10; a database 21 for storing dedicated user's data established by the user 1 when first loginning the web page server 2; and an identifying module 22 for searching in the database 21 for user's data corresponding to a mobile phone number received by the wireless communication module 20, so as to identify if the user 1 has registered in the web page server 2.

Upon receiving the wireless communication signal transmitted from the mobile phone 10 with the WAP function, the wireless communication module 20 converts a wireless markup language (WML) message transmitted from the mobile phone 10 into a conventional HTTP message, which is sent to the web page server 2, for allowing the web page server 2 to operate according to the HTTP message. On the other hand, when the web page server 2 desires to send an operation result back to the mobile phone 10, the wireless communication module 20 needs to convert a HTTP message into a WML message, so as to display the operation result on the mobile phone 10 of the user 1. If the user 1 is identified to first login the web page server 2, the user 1 needs to input a login account, an identification code, a mobile phone number, etc., so as to accordingly establish dedicated user's data for allowing the user 1 to login the web page server 2 thereafter, and the dedicated user's data are stored in the database 21. The user's data can be established in several manners, including that first, the user 1 registers in the web page server 2 through wired network connection constructed via a computer device to the web page server 2; second, the user 1 fills up an application form and submits it to the web page server 2 for data establishment; and third, the user 1 registers in the web page server 2 through wireless network connection constructed via the mobile phone 10 to the web page server 2.

If the user 1 uses the mobile phone 10 with the WAP function to login the web page server 2, the identify module 22 searches in the database 21 for user's data corresponding to a mobile phone number contained in a request signal received by the wireless communication module 20. Next, a login account and an identification code inputted by the user 1 thorough the use of a keypad of the mobile phone 10 are compared with the searched user's data; if the inputted data match the searched user's data, the user 1 is allowed to login the web page server 2. The identifying module 22 has processing software for allowing the user 1 to input data thereto, wherein the software is transmitted by the wireless communication module 20 to the mobile phone 10 for displaying message fields to be inputted with the login account and the identification code by the user 1. Since the interaction between the user 1 and the web page server 2 employs conventional network communication processes, it is not further described herein, with the only depiction of associated part relating to the invention.

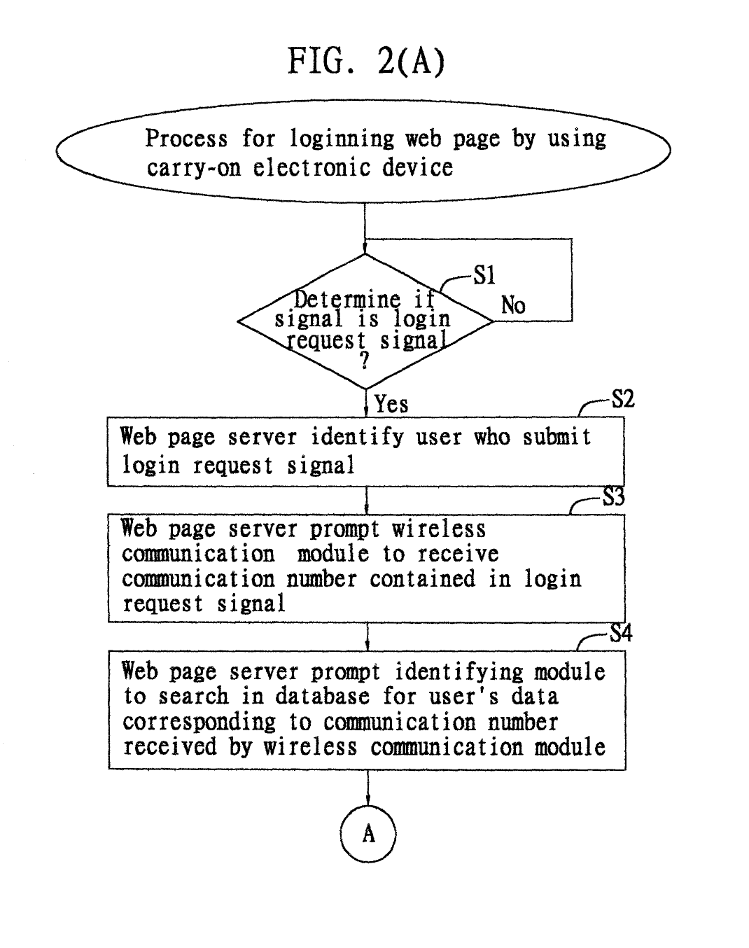

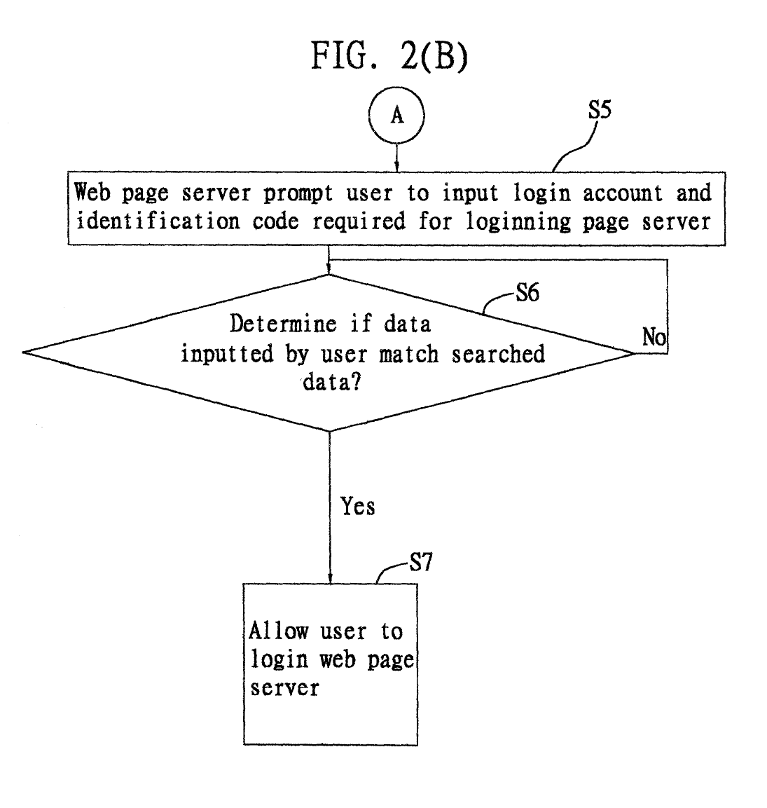

Referring to FIGS. 2(A)-2(B), they illustrate a login method for use with a carry-on electronic device in the use of a login system for use with a carry-on electronic device of the invention. The following description is made with reference to FIGS. 1 and 2(A)-2(B).

First in step S1, a web page server 2 determines if a wireless communication module 20 receives a login request signal. If the login request signal is received, then step S2 is followed; or else, the step S1 is returned.

In step S2, the web page server 2 identifies a user 1 who submits the login request signal, and then step S3 is followed.

In step S3, the web page server 2 prompts the wireless communication module 20 to receive a mobile phone number contained on the login request signal transmitted by a mobile phone 10 of the user 1, and then step S4 is followed.

In step S4, the web page server 2 prompts an identifying module 22 to search in a database 21 for user's data corresponding to the mobile phone number received by the wireless communication module 20, and then step S5 is followed.

In step S5, the web page server 2 prompts the user 1 at the mobile phone 10 to input a login account and an identification code required for loginning the web page server 2, and then step S6 is followed.

In step S6, the web page server 2 determines if the login account and identification code inputted by the user 1 match those in the searched user's data. If the inputted data match the searched user's data, then step S7 is followed; or else, the step S6 is returned.

In step S7, the user 1 at the mobile phone 10 is allowed to login the web page server 2.

Therefore, in the use of the login method and system for use with a carry-on electronic device of the invention, the user 1 can interact with the web page server 2 via the wireless network connection between the mobile phone 10 and the web page server 2, wherein the interaction between the user 1 and the web page server 2 is performed in a secure manner, which identifies the identify of a person who logins the server, so as to prevent a person with no authorization from loginning the server.

The invention has been described using exemplary preferred embodiments. However, it is to be understood that the scope of the invention is not limited to the disclosed embodiments. On the contrary, it is intended to cover various modifications and similar arrangements. For example, besides the mobile phone 10, the user 1 can also use a mobile device supported with wireless communication, such as notebook computer, personal digital assistant (PDA) or the like, so as to establish wireless connection to the web page server 2; wireless communication protocol applied between the mobile device and the web page server 2 is not limited to WAP. The scope of the claims, therefore, should be accorded the broadest interpretation so as to encompass all such modifications and similar arrangements.

What is claimed is:

1. A login method for use with a carry-on electronic device, for allowing a user to login a web page server via a carry-on electronic device, so as to read or download required data from the web page server, wherein the user who first logins the web page server needs to input a login account, an identification code and a communication number required for registering in the web page server, so as to establish dedicated user's data for the user, and store the user's data in a database of the web page server; the login method comprising the steps of:
(1) determining via the web page server if a wireless communication module receives a login request signal transmitted from the carry-on electronic device, wherein if the login request signal is received, then step (2) is followed; or else, then the step (1) is repeated;
(2) prompting the wireless communication module via the web page server to receive a communication number contained in the login request signal transmitted from the carry-on electronic device;
(3) searching the database via the web page server for user's data corresponding to the communication number received by the wireless communication module;
(4) prompting the user at the carry-on electronic device via the web page server to input a login account and an identification number required for loginning the web page server;
(5) determining via the web page server if the login account and the identification number inputted by the user match those in the searched user's data, wherein if the inputted data match the searched data, then step (6) is followed; or else, the step (5) is repeated; and
(6) allowing the user at the carry-on electronic device to login the web page server.

2. The login method of claim 1, wherein the user's data are established in a manner that the user registers in the web page server via wired network connection constructed between a computer device and the web page server.

3. The login method of claim 1, wherein the user's data are established in a manner that the user fills up an application form and submits the form to the web page server.

4. The login method of claim 1, wherein the user's data are established in a manner that the user registers in the web page server via wireless network connection constructed between the carry-on electronic device and the web page server.

5. The login method of claim 1, wherein the carry-on electronic device is a mobile phone.

6. The login method of claim 1, wherein the carry-on electronic device is a personal digital assistant (PDA).

7. The login method of claim 1, wherein the carry-on electronic device is a notebook computer.

8. The login method of claim 5, wherein the wireless communication module is applied under wireless application protocol (WAP).

9. A login system for use with a carry-on electronic device, comprising:
at least one user having a carry-on electronic device supported with a wireless network communication function; and
a web page server for allowing the user having the carry-on electronic device to login the web page server, so as to download required data to the carry-on electronic device, wherein the web page server includes a database for establishing and storing dedicated user's data of a login account, an identification code and a communication number inputted by the user; a wireless communication module for receiving a communication number contained in a wireless communication signal transmitted from the carry-on electronic device of the user; and an identifying module for searching in the database for user's data corresponding to the communication number received by the wireless communication module; then, the web page server prompts the user at the carry-on electronic device to input a login account and an identification number required for loginning the web page server, and compares the inputted login account and identification number with those in the searched user's data; and if the inputted data match the searched data, the user at the carry-on electronic device is allowed to login the web page server for data downloading.

10. The login system of claim 9, wherein the user's data are established in a manner that the user registers in the web page server via wired network connection constructed between a computer device and the web page server.

11. The login system of claim 9, wherein the user's data are established in a manner that the user fills up an application form and submits the form to the web page server.

12. The login system of claim 9, wherein the user's data are established in a manner that the user registers in the web page server via wireless network connection constructed between the carry-on electronic device and the web page server.

13. The login system of claim 9, wherein the carry-on electronic device is a mobile phone.

14. The login system of claim 9, wherein the carry-on electronic device is a personal digital assistant (PDA).

15. The login system of claim 9, wherein the carry-on electronic device is a notebook computer.

16. The login system of claim 9, wherein the wireless network communication function is a wireless application protocol (WAP) function.
